(19) United States
(12) Patent Application Publication
(10) Pub. No.: US 2011/0290287 A1
(43) Pub. Date: Dec. 1, 2011

(54) Water-saving toilette wash device

(76) Inventor: Weicheng Li, Beijing (CN)

(21) Appl. No.: 12/931,505

(22) Filed: Feb. 3, 2011

(30) Foreign Application Priority Data
May 26, 2010 (CN) 201010186953.3

(51) Int. Cl. B08B 1/00

(52) U.S. Cl. 134/198

(57) ABSTRACT

The invention discloses a water-saving toilette wash device and pertains to the technical field of toilette articles. The technical scheme of the invention: It comprises a water cleaning pad and a support plate behind the water cleaning pad. Wiper gibbosities are disposed at the front face of the water cleaning pad and arranged in lines or in texture. Water outlet openings are disposed in the water cleaning pad. A water hose accessible to the water outlet openings is installed on the support plate. The wholesome effect of the technical scheme provided by embodiments of the invention: The wash pad continuously and directly sends clear water to the surface to be cleaned and applies water to and washes head, neck and face with the water cleaning pad synchronously. It avoids the useless water flow and spills, raises wash efficiency, and doesn't increase the water consumption of the wash per se, so that it can significantly reduce waste of water resource. The volume of the saved water may be above 80% of the consumption of the current washing methods. The wiper gibbosities not only make the cleaning of head, neck and face more thorough, more convenient and faster but also have a desirable massage and healthcare effect. As a whole, the product has a simple structure and low production cost and makes for wide application.

### FIELD OF THE INVENTION

The invention relates to the technical field of toilette articles, particularly to a water-saving toilette wash device.

### BACKGROUND OF THE INVENTION

Currently, the main wash methods are washing with hands, wash with a towel and wash with a basin. The wash with hand is a method by which hands collect water under a tap, carry the water to head, neck and face and wash them. In order to achieve a good wash effect, this process of carrying water from a tap to head, neck and face needs to be repeated several times. In this process, the tap can't be shut and the water keeps flowing, so most of the clear water is wasted. Further, much of the water, in hands leaks. Particularly, when the hands or the head, neck and face with soap or cleansing milk foam are washed, more repeated times are needed and more water will be wasted. The wash with a towel is a method by which a towel is horizontally placed on a palm and wetted under a tap and then is used to clean head, neck and face. Similar to the wash with hands, the wash with a towel also needs the repeated conveyance of water between a tap and the head, neck and face. As the tap is not shut, this also results in waste of a large amount of clear water. Moreover, it is inevitable that the foam of soap or cleansing milk and the dirty water after wash will permeate into the porous towel, so the towel has to be washed repeatedly. This not only adds more trouble and wastes time but also increases the waste of water resource. The wash with a basin is a method by which water is put into a basin and two hands carry water to head, neck and face and wash them. During the wash, two hands rub soap or cleansing milk to generate foam and use the foam to clean head, neck and face. After the cleaning, the foam on hand is washed down and then water is taken from the basin to wash head, neck and face. In this method, hands need to carry water from the basin to head, neck and face repeatedly. It is very troublesome and time consuming; furthermore, during the wash, the generated foam of soap or cleansing milk also enters the basin. In fact, unclean water is used to rinse head, neck and face in the later stage of the wash. The cleaning is not thorough. Furthermore, many people will empty the basin, simply wash the basin, fill the basin with clear water again and then use the water to clean head, neck and face. Consequently, it will also create remarkable waste of water; furthermore, when head, neck and face are rinsed with water by hands, it is likely that a very thin layer of the residual soap or cleansing milk foam will stay on the head, neck and face.

Some washing tools exist in prior art, but they all have the defects like complex structure, high production cost and difficult popularization.

In the realization process of the invention, the inventor discovered the prior art had at least the following problems: the existing wash methods have the defects of water waste, complex operation, incomplete cleaning, long operation time, complex structure and/or high production cost.

### SUMMARY OF THE INVENTION

In order to realize the reduction of water waste, fast and convenient use, thorough cleaning, simple structure and low cost, the embodiments of the invention provide a water-saving toilette wash device. The technical scheme is as follows:

A water-saving toilette wash device comprises a water cleaning pad and a support plate behind the water cleaning pad. Wiper gibbosities are disposed at the front face of the water cleaning pad and arranged in lines or in texture. Water outlet openings are disposed in the said water cleaning pad. A hose joint accessible to the said water outlet openings is disposed on the said support plate. A water hose is disposed on the said hose joint.

In order to realize the object of the foregoing invention in a better way, the invention may also include the following technical scheme: At the end of the said water hose farther from the said support plate, a water inlet joint or a water inlet joint with ear-shaped pieces is disposed, too.

In order to realize the object of the foregoing invention in a better way, the invention may also include the following technical scheme: The said water cleaning pad and/or the said wiper gibbosities may be made from silicon rubber.

In order to realize the object of the foregoing invention in a better way, the invention may also include the following technical scheme: A handle is disposed at the rear face of the said support plate.

In order to realize the object of the foregoing invention in a better way, the invention may also include the following technical scheme: A storage box cover is disposed at the rear face of the said support plate. A through hole for the hose is disposed on the said storage box cover.

In order to realize the object of the foregoing invention in a better way, the invention may also include the following technical scheme: A flow regulating valve is disposed on the said water hose.

In order to realize the object of the foregoing invention in a better way, the invention may also include the following technical scheme: A water storage chamber is disposed between the said support plate and the said water cleaning pad. The said water hose accesses the said water outlet openings through the said water storage chamber.

In order to realize the object of the foregoing invention in a better way, the invention may also include the following technical scheme: There is a plurality of said water outlet openings, they are distributed on the said water cleaning pad in a decentralized way.

In order to realize the object of the foregoing invention in a better way, the invention may also include the following technical scheme: The said water outlet openings are disposed on the upper part of the said water cleaning pad.

In order to realize the object of the foregoing invention in a better way, the invention may also include the following technical scheme: The said water cleaning pad locates a water outlet valve cap on the center of said water outlet openings.

In order to realize the object of the foregoing invention in a better way, the invention may also include the following technical scheme: Both the said water outlet openings and the said water outlet valve cap are located on the bottom surface of an upwardly protuberant shallow dish on the said water cleaning pad. A convex water outlet platform that clings to the inner side of the said shallow dish is disposed on the said support plate.

The wholesome effect of the technical scheme provided by embodiments of the invention: The water-saving toilette wash device continuously and directly sends clear water to the surface to be cleaned and applies water to and washes head, neck and face with the said water cleaning pad synchronously. In this way, it avoids the useless water flow and spills, raises wash efficiency, and doesn't increase the water consumption of the wash per se, so that it can significantly reduce waste of water resource. The volume of the saved water may be above 80% of the consumption of the current washing methods. As the said wiper gibbosities on the said water cleaning pad can effectively wipe out the dirt and foam on the surface of head, neck and face, the cleaning is more thorough and faster, the wash time is greatly shortened and the consumption and waste of water resource are further reduced. The said water cleaning pad and the said wiper gibbosities are made from silicon rubber and other elastic and soft materials. They not only have desirable decontamination performance but also are soft and comfortable and show a good effect on massage and healthcare. Moreover, the invention has a simple overall structure and low production cost and makes for wide application.

### BRIEF DESCRIPTION OF THE DRAWINGS

In order to more clearly illustrate the technical scheme of the embodiments of the invention, the drawings used in the embodiments are briefly described below. Obviously the following drawings are some examples of the invention. Those of ordinary skill in the art may also acquire other drawings according to these drawings without paying creative labor.

FIG. 1 is a front structural view of Embodiment (1) of the invention.

FIG. 2 is a side view of FIG. 1.

FIG. 3 is a look-down view of FIG. 1.

FIG. 4 is a front structural view of Embodiment (2) of the invention.

FIG. 5 is a side view of FIG. 4.

FIG. 6 is a look-up view of FIG. 4.

FIG. 7 is a front structural view of ear-shaped piece of Embodiment (2) of the invention.

In drawings, the components for which the mark numbers stand are listed below:

| | | | |
|---|---|---|---|
| 1. | water cleaning pad | 2. | support plate |
| 3. | hose joint | 4. | water hose |
| 5. | water inlet joint | 6. | handle |
| 7. | wiper gibbosities | 8. | water outlet opening |
| 9. | water outlet valve cap | 10. | water outlet convex platform |
| 11. | shallow dish | 12. | through hole |
| 13. | storage box cover | 14. | water storage chamber |
| 15. | ear-shaped piece | 16. | flow regulating valve |

### DETAILED DESCRIPTION OF THE EMBODIMENTS

### Embodiment 1

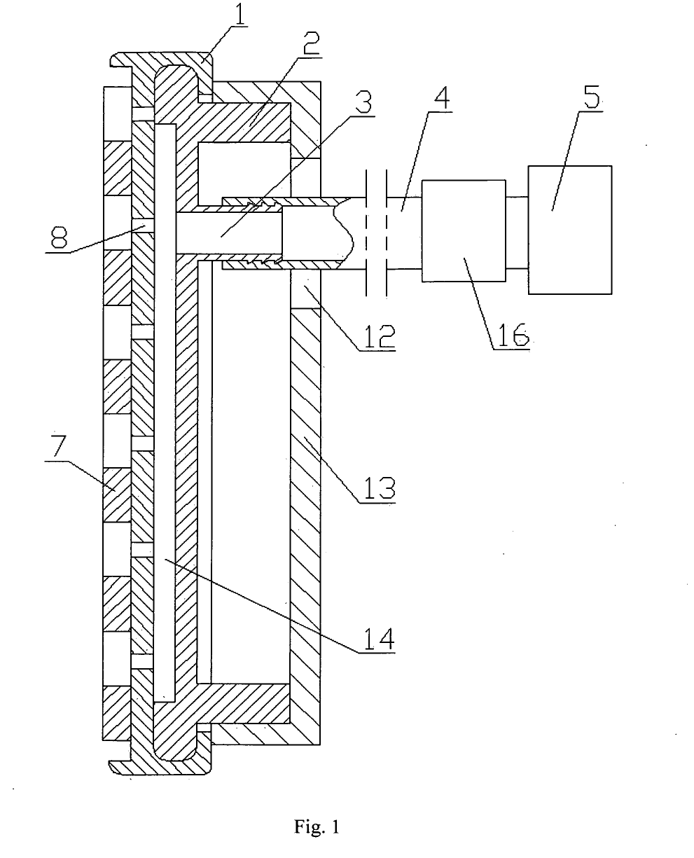

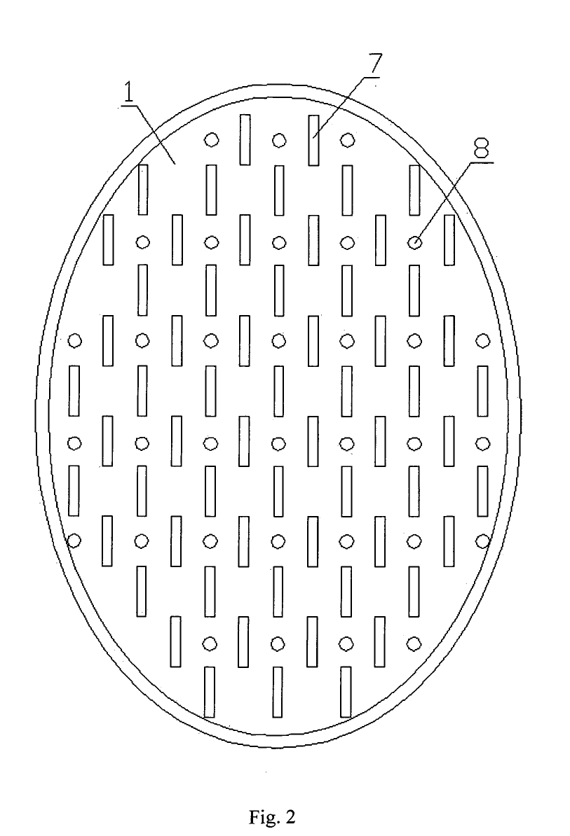

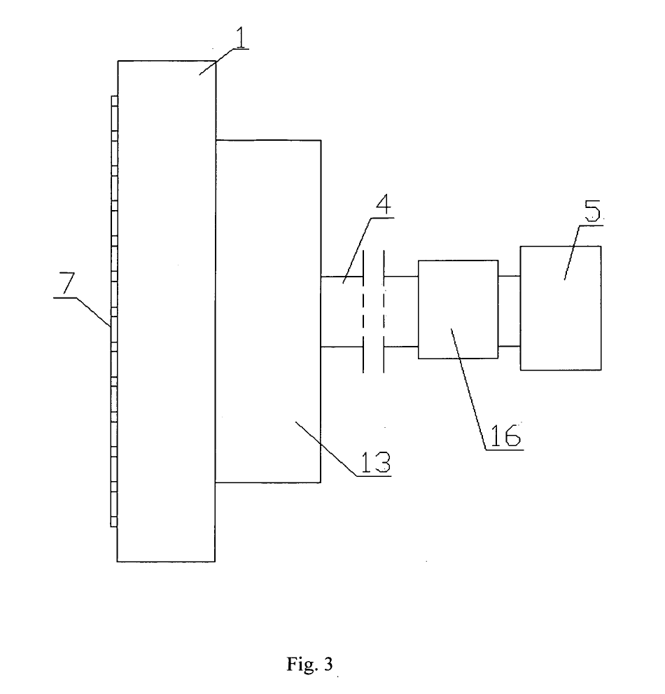

FIG. 1, FIG. 2 and FIG. 3 are the front structural view, side view and look-down view of Embodiment (1) of the invention. Its technical scheme: A water-saving toilette wash device, comprising a support plate 2 and a water cleaning pad 1 fastened to the front side of the support plate 2; wiper gibbosities 7 are disposed on the front face of the water cleaning pad 1, they are evenly and longitudinally arranged; a plurality of water outlet openings 8 is disposed on the water cleaning pad 1; a hose joint 3 accessible to the water outlet openings 8 is disposed on the support plate 2; a water hose 4 is connected to the hose joint 3; a water inlet joint 5 is disposed at the end of the water hose 4 farther from the support plate 2; a water storage chamber 14 is arranged between the support plate 2 and the water cleaning pad 1; the water hose 4 accesses the water outlet openings 8 through the hose joint 3 and the water storage chamber 14; a storage box cover 13 is disposed at the rear face of the support plate 2; a through hole 12 is disposed on the storage box cover 13; a flow regulating valve 16 is disposed on the water hose 4, too.

The water cleaning pad 1 and the wiper gibbosities 7 are made from silicon rubber or other elastic and soft materials.

The wiper gibbosities 7 are disposed on the front face of the water cleaning pad 1. When the water cleaning pad 1 is moved left and right or moved around on head, neck and face, by means of brushing, rubbing, wiping, kneading and other operations, the cleaning is fast and thorough and a massage effect is generated.

The storage box cover 13 is disposed at the rear face of the support plate 2. A through hole 12 is disposed on the storage box cover 13. During use, the storage box cover 13 may be served as a handle for easy holding and use; when it is not used, the water hose 4 and the water inlet joint 5 will be withdrawn into the storage box cover 13. It is tidy and clean. Alternatively, the water hose 4 may be withdrawn into the storage box cover 13 via the through hole 12, while the water inlet joint 5 stays outside the storage box cover 13. During use, the water hose 4 may be easily pulled out by simply holding the water inlet joint 5.

The preferred dimensions of the wiper gibbosities 7: Length is 5˜10 mm, Width is 0.5˜1.5 mm; high is 2˜5 mm.

The water inlet joint 5 is made from elastic rubber and connected to the water outlet of a tap by relying on its elasticity.

A flow regulating valve 16 may be disposed on the water hose 4, too. The opening degree of the valve may be selected subject to the wash speed of the individuals, thereby effectively controlling water output and output speed, reducing waste of water resource and improving wash comfort.

The water-saving toilette wash device provided by Embodiment (1) of the invention has a simple overall structure and low production cost and makes for wide application. During use, the water inlet joint 5 is connected to the outlet of a tap, clear water flows to the water cleaning pad 1 after the tap is opened, the storage box cover 13 of the support plate 2 is held in a hand, the water cleaning pad 1 is placed on head, neck and face to preliminarily wet them; then the tap is closed, soap or cleansing milk is applied on head, neck, face or the water cleaning pad 1 and spread evenly, the water cleaning pad 1 is placed on the head, neck and face to rub and clean them; the tap is opened to supply water after the cleaning, the head, neck and face be watered and washed synchronously to efficiently and quickly remove the foams and dirty liquid generated during the rubbing and cleaning.

The water-saving toilette wash device provided by Embodiment (1) of the invention continuously and directly sends clear water to the surfaces of the head, neck and face to rub and clean them synchronously with the water cleaning pad 1. In this way, it avoids the useless water flow and spills, raises wash efficiency, and doesn't increase the water consumption of the wash per se, so that it can significantly reduce waste of water resource. The volume of the saved water may be above 80% of the consumption of the current washing methods. As the said wiper gibbosities on the said water cleaning pad can effectively wipe out the dirt and foam on the surface of head, neck and face, the cleaning is more thorough and faster, the wash time is greatly shortened and the consumption and waste of water resource are further reduced. The said water cleaning pad and the said wiper gibbosities are made from silicon rubber and other elastic and soft materials. They not only have desirable decontamination performance but also are soft and comfortable and show a good effect on massage and healthcare.

### Embodiment 2

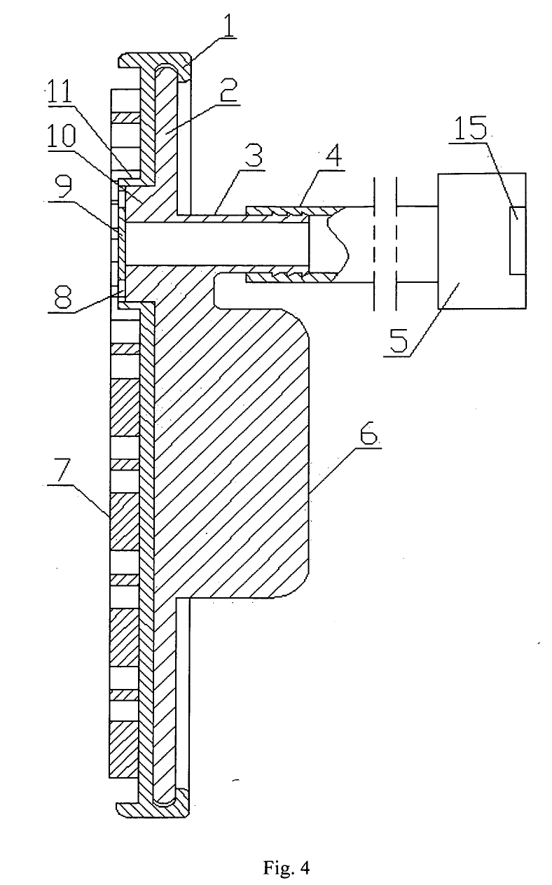

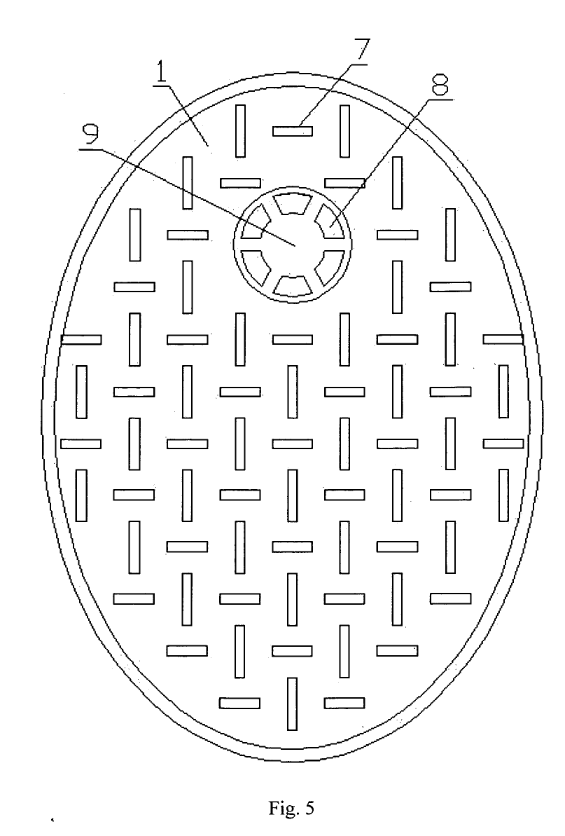

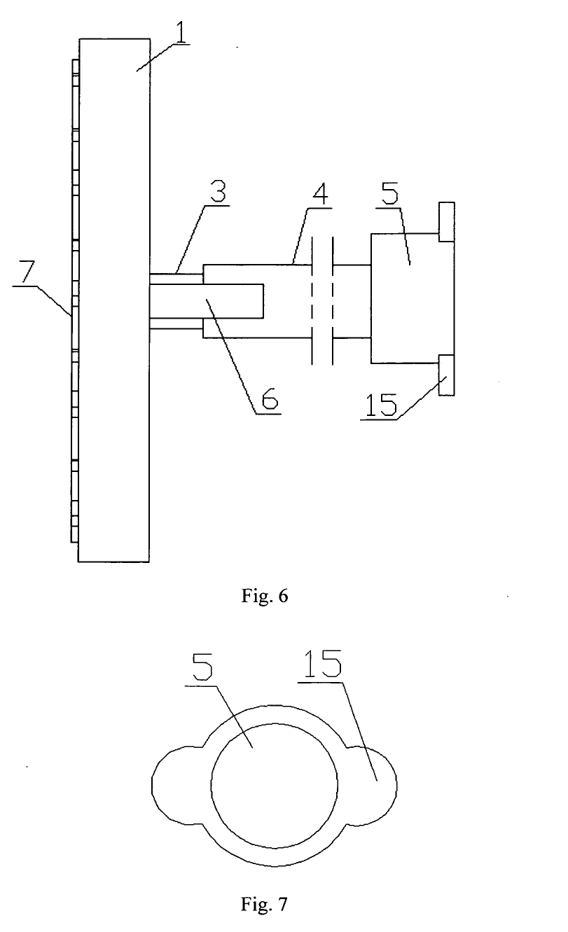

FIG. 4, FIG. 5 and FIG. 6 are the front structural view, side view and look-up view of the embodiment (2) of the invention. Its technical scheme: A water-saving toilette wash device comprises a water cleaning pad 1 and a support plate 2 fastened to the rear side of the water cleaning pad 1; wiper gibbosities 7 are disposed on the front face of the water cleaning pad 1, they are evenly arranged in an alternately longitudinal and transversal way; a forward protuberant shallow dish 11 is disposed in the upper part of the front face of the water cleaning pad 1; a water outlet valve cap 9 is disposed at the center of the bottom surface of the shallow dish 11; water outlet openings 8 are arranged around the water outlet valve cap 9; a water outlet convex platform 10 clinging to the inner side of the shallow dish 11 is disposed on the support plate 2; a hose joint 3 accessible to the water outlet openings 8 is disposed on the support plate 2; a water hose 4 is connected to the hose joint 3; an water inlet joint 5 with ear-shaped pieces is disposed at one end of the water hose 4 farther from the support plate 2; a handle 6 is disposed at the rear face of the support plate 2.

The water cleaning pad 1 and the wiper gibbosities 7 are made from silicon rubber or other elastic and soft materials.

Water outlet openings 8 are disposed around the water outlet valve cap 9. During wash, the tap is opened. The clear water flows to the space under the water outlet valve cap 9 via the water hose 4 and the hose joint 3. Under the action of water pressure, the water outlet valve cap 9 is pushed open and water flows out of the water outlet openings 8 around the water outlet valve cap 9. The water outlet valve cap 9 avoids the discomfort resulting from the direct jet of the out coming water. Furthermore, when water pressure is lower than external pressure, the water outlet valve cap 9 will be closed automatically, thereby keeping the dirty water from flowing adversely into the hose joint 3. In addition, the flow of clear water may be regulated through changing the external pressure of the water outlet valve cap 9.

The water outlet convex platform 10 clinging to the inner side of the shallow dish 11 is disposed on the support plate 2 and plays a certain role in positioning the water cleaning pad 1 on the support plate 2. Meanwhile, it is not easy that the clear water flowing out of the water outlet opening 8 after the water outlet valve cap 9 is pushed open enters the space between the water cleaning pad 1 and the support plate 2, thereby effectively avoiding the retention of clear water between the water cleaning pad 1 and the support plate 2, bacterial multiplication induced by damp as well as contamination to the clear water flowing out of the water outlet openings 8.

The wiper-gibbosities 7 are disposed on the front face of the water cleaning pad 1. When the water cleaning pad 1 is moved left and right or moved around on head, neck and face, by means of brushing, rubbing, wiping, kneading and other operations, the cleaning is fast and thorough and a massage effect is generated.

The preferred dimensions of the wiper gibbosities 7: Length is 5˜10 mm, Width is 0.5˜1.5 mm; High is 2˜5 mm.

The water inlet joint 5 is made from elastic rubber. Ear-shaped pieces are disposed at the two sides of the port so that the diameter of the water inlet joint 5 can be pulled larger. The water inlet joint 5 is connected to the water outlet of a tap by relying on its elasticity.

The water-saving toilette wash device provided by Embodiment (2) of the invention has a simple overall structure and low production cost and makes for wide application. During use, the water inlet joint 5 is connected to the outlet of a tap, clear water flows to the water cleaning pad 1 after the tap is opened, the handle 6 of the support plate 2 is held in a hand, the water cleaning pad 1 is placed on head, neck and face to preliminarily wet them; then the tap is closed, soap or cleansing milk is applied on head, neck, face or the water cleaning pad 1 and spread evenly, the water cleaning pad 1 is placed on the head, neck and face to rub and clean them; the tap is opened to supply water after the cleaning, the head, neck and face be watered and washed synchronously to efficiently and quickly remove the foams and dirty liquid generated during the rubbing and cleaning.

The water-saving toilette wash device provided by Embodiment (2) of the invention continuously and directly sends clear water to the surfaces of the head, neck and face to rub and clean them synchronously with the water cleaning pad 1. In this way, it avoids the useless water flow and spills, raises wash efficiency, and doesn't increase the water consumption of the wash per se, so that it can significantly reduce waste of water resource. The volume of the saved water may be above 80% of the consumption of the current washing methods. As the said wiper gibbosities on the said water cleaning pad can effectively wipe out the dirt and foam on the surface of head, neck and face, the cleaning is more thorough and faster, the wash time is greatly shortened and the consumption and waste of water resource are further reduced. The said water cleaning pad and the said wiper gibbosities are made from silicon rubber and other elastic and soft materials. They not only have desirable decontamination performance but also are soft and comfortable and show a good effect on massage and healthcare.

For above stated embodiments are only some preferred implementation examples of the invention and not intended to limit the invention. Any general modifications, substitutions and improvements made without departing from the spirit and principle of the invention shall be regarded as being covered by the protective range of this invention.

1. A water-saving toilette wash device, wherein it comprises a water cleaning pad and a support plate behind the said water cleaning pad, wiper gibbosities are disposed at the front face of the said water cleaning pad and arranged in lines or in texture, water outlet openings are disposed in the said water cleaning pad, a hose joint accessible to the said water outlet openings is disposed on the said support plate, a water hose is disposed on the said hose joint.

2. As the said water-saving toilette wash device in claim 1, wherein, at the end of the said water hose farther from the said support plate, a water inlet joint or a water inlet joint with ear-shaped pieces is disposed.

3. As the said water-saving toilette wash device in claim 1, wherein, a handle is disposed at the rear face of the said support plate.

4. As the said water-saving toilette wash device in claim 1, wherein, a storage box cover is disposed at the rear face of the said support plate, a through hole for the said water hose is disposed on the storage box cover.

5. As the said water-saving toilette wash device in claim 1, wherein, a flow regulating valve is disposed on the said water hose.

6. As any said water-saving toilette wash device in claim 1-5, wherein, a water storage chamber is disposed between the said support plate and the said water cleaning pad, the said water hose accesses the said water outlet openings through the said water storage chamber.

7. As the said water-saving toilette wash device in claim 6, wherein, there is a plurality of the said water outlet openings, they are distributed on the said water cleaning pad in a decentralized way.

8. As any said water-saving toilette wash device in claim 1-5, wherein, the said water outlet openings are disposed on the upper part of the said water cleaning pad.

9. As the said water-saving toilette wash device in claim 8, wherein, the said water cleaning pad locates a water outlet valve cap on the center of said water outlet openings.

10. As the said water-saving toilette wash device in claim 9, wherein, both the said water outlet openings and the said water outlet valve cap are located on the bottom surface of an upwardly protuberant shallow dish on the said water cleaning pad, a convex water outlet platform that clings to the inner side of the said shallow dish is disposed on the said support plate.
